(19) United States
(12) Patent Application Publication
(10) Pub. No.: US 2014/0193702 A1
(43) Pub. Date: Jul. 10, 2014

(54) Housing for a Galvanic Element

(71) Applicants: Thomas Woehrle, Stuttgart-Feuerbach (DE); Patrick Auracher, Vaihingen/Enz (DE); Aleksandar Petrevski, Schwieberdingen (DE); Conrad Bubeck, Esslingen (DE)

(72) Inventors: Thomas Woehrle, Stuttgart-Feuerbach (DE); Patrick Auracher, Vaihingen/Enz (DE); Aleksandar Petrevski, Schwieberdingen (DE); Conrad Bubeck, Esslingen (DE)

(73) Assignees: Samsung SDI Co., Ltd., Yongin-si, Gyeonggi-do (KR); Robert Bosch GmbH, Stuttgart (DE)

(21) Appl. No.: 13/825,300

(22) PCT Filed: Aug. 19, 2011
(86) PCT No.: PCT/EP2011/064255

§ 371 Date: Feb. 5, 2014

(30) Foreign Application Priority Data
Sep. 21, 2010 (DE) 10 2010 041 143.4

(51) Int. Cl. H01M 2/02

(52) U.S. Cl. CPC H01M 2/0287; H01M 2/0262; H01M 2/0277
USPC 429/176; 429/163; 29/469.5

(57) ABSTRACT

A method for producing a housing for a galvanic element includes forming a metal base housing to improve the insulation properties of the housing and gluing an insulation film to at least one outer surface of the base housing.

The present invention relates to a process for the production of a housing for an electrochemical element and to this type of housing and electrochemical element.

### PRIOR ART

The application sector of electrochemical elements, such as lithium ion cells, determines whether they are integrated either within what are known as soft packages or within rigid housings known as hard cases, these serving inter alia for the electrical insulation of the electrochemical element.

Soft packages can be produced via deep-drawing of metal-plastics composite materials which comprise a metallic layer of thickness below 50 μm. Materials of this type are described by way of example in the publication DE 11 2006 001 372 T5.

However, some application sectors, such as the motor vehicle sector, require rigid housings with a stronger metallic housing wall. These cannot be produced via deep-drawing of metal-plastics composite materials, since when the thickness of the metallic layer is relatively great the plastics layers can become overstretched at the edges and can fracture.

In order to achieve electrical insulation of rigid housings, a “shrink tube” is usually pulled over the sides of the housing. However, the shrink tube does not cover the upper and lower region of the housing, and these have to be covered with electrical insulation by further additional steps in a process. When the shrink tube is applied it is moreover impossible to avoid introducing a certain amount of heat on to the cell.

### DISCLOSURE OF THE INVENTION

The present invention provides a process for the production of a housing for an electrochemical element, comprising the following steps:
a) molding of a metallic housing structure and
b) applying an insulation foil by adhesive bonding to at least one external area of the housing structure.

The process according to the invention permits the production of electrically insulated, rigid housings for electrochemical elements, such as lithium ion cells, in particular for motor vehicles, with a smaller number of steps in a process. Another advantage of adhesive bonding is that the insulation foil can be attached securely to the relevant area on the housing. It is thus possible firstly to achieve an advantageous improvement in heat dissipation from the interior of the housing and of cell—when comparison is made with the shrink tube technique. Secondly, this method improves impact resistance and scratch resistance—when comparison is made with insulation foils applied by shrinking.

The molding of the housing structure in step a) is preferably achieved via a forming process, for example via forming under a combination of tensile and compressive conditions or by forming under compressive conditions, in particular via deep-drawing or extrusion.

The housing structure in step a) can in particular be molded from aluminum, from an aluminum alloy, iron, or an iron alloy, such as stainless steel. In particular, a housing structure with a wall thickness≧100 μm, in particular ≧125 μm, for example≧150 μm, or ≧200 μm, or ≧400 μm, or ≧650 μm, for example≧100 μm, or ≧125 μm, or ≧150 μm, or ≧200 μm, or ≧400 μm, or ≧650 μm, and/or up to ≦1.5 mm can be molded in step a). By way of example, it is possible in step a) to mold a prismatic housing structure, for example with a plurality of, in particular four, sides, and with a base.

For the purposes of the process of the invention, it is in principle possible to apply the adhesive and the insulation foil separately from one another or in the form of a layer system.

For the purposes of one embodiment, the insulation foil used in step b) comprises a layer system made of at least one base layer and of at least one adhesive layer. Adhesive bonding can advantageously be used in step b) to apply an insulation foil with adhesive layer to the housing structure, by using the adhesive layer, with resultant simplification of the process. The base layer of the insulation foil used in step b) is preferably composed of a plastic. By way of example, the base layer of the insulation foil used in step b) can have a thickness≧10 μm, in particular ≧12 μm, for example from ≧10 μm to ≦70 μm, by way of example from ≧19 μm to ≦25 μm.

For the purposes of another embodiment, the insulation foil used in step b) comprises at least one base layer made of a polymer selected from the group consisting of polyesters, for example polyethylene terephthalate (PET) and/or polyethylene naphthalate (PEN), silicones, polyolefins, for example polypropylene (PP), polyhaloolefins, for example polyvinyl chloride (PVC), polystyrenes (PS), polyimides (PI), and combinations thereof. Polymers of this type have proven particularly advantageous as base layer. In particular, the at least one base layer of the insulation foil used in step b) can be composed of a polymer of this type. The term “composed” here can in particular mean that the polymer can comprise additives, for example in order to improve thermal conductivity. By way of example, the at least one base layer, or the polymer, of the insulation foil used in step b) can comprise at least one additive selected from the group consisting of boron nitride, aluminum oxide, aluminum nitride, and glass fibers, in particular boron nitride, aluminum oxide, aluminum nitride, and mixtures thereof. By way of example, the at least one base layer of the insulation foil used in step b) can be a thermosilicone foil, for example a thermosilicone foil marketed by Kunze, Germany, with trademark HEATPAD®.

Step b) can in principle use not only a pressure-sensitive adhesive (adhesive without hardening mechanism) but also an adhesive that sets by a chemical or physical route, for example a hot-melt adhesive. It is preferable that the insulation foil used in step b) comprises at least one adhesive layer made of a pressure-sensitive adhesive. It is thus advantageously possible to avoid waiting times and thermal effects for the setting process. The thickness of the at least one adhesive layer of the insulation foil used in step b) can by way of example be ≧10 μm, in particular ≧20 μm, for example from ≧25 μm to ≦35 μm.

For the purposes of another embodiment, the insulation foil used in step b) comprises at least one adhesive layer made of an adhesive selected from the group consisting of polysiloxane-based adhesives, acrylate-based adhesives, rubber-based adhesives, polyurethane-based adhesives, epoxy-resin-based adhesives, and combinations thereof. Adhesives of this type have proven to be particularly advantageous. In particular, the at least one adhesive layer of the insulation foil used in step b) can be composed of an adhesive of this type. The term “composed” here can in particular mean that the adhesive can comprise additives, for example in order to improve thermal conductivity. By way of example, the at least one adhesive layer of the insulation foil used in step b) can comprise at least one additive selected from the group consisting of boron nitride, aluminum oxide, aluminum nitride, and glass fibers, in particular boron nitride, aluminum oxide, aluminum nitride, and mixtures thereof.

Surprisingly, it has been found that insulation foils with a base layer of this type are intrinsically capable of providing adequate electrical insulation or adequately high dielectric strength and moreover are also useful for their heat-dissipation capability.

However, the electrical insulation properties, and the thermal conductivity, of the housing can be further optimized by using two or more base layers.

By way of example, to this end step b) can use an insulation foil which comprises a layer system made of at least two base layers and of at least one adhesive layer, for example of at least two base layers and of at least two adhesive layers, in particular in an alternating arrangement. The base layers and/or adhesive layers of the insulation foil used in step b) can be of either identical or different design here. The term different applied here to base layers, adhesive layers, polymers, additives, and adhesives can mean those having different constituent materials or else can mean base layers, adhesive layers, polymers, additives, and adhesives which have the same constituent materials but a different, in particular percentage, constitution of constituent materials.

By way of example, step b) can use an insulation foil which comprises at least one first base layer and one second base layer differing from the first base layer. The first base layer here can comprise a first polymer or be composed thereof, and the second base layer can comprise a second polymer differing from the first polymer, or be composed thereof. In particular, the first base layer here can comprise, or be composed of, a first polymer selected from the group consisting of polyesters, for example polyethylene terephthalate (PET) and/or polyethylene naphthalate (PEN), silicones, polyolefins, for example polypropylene (PP), polyhaloolefins, for example polyvinyl chloride (PVC), polystyrenes (PS), polyimides (PI), and combinations thereof. The second base layer here can in particular comprise, or be composed of, a second polymer differing from the first polymer and likewise selected from the group consisting of polyesters, for example polyethylene terephthalate (PET) and/or polyethylene naphthalate (PEN), silicones, polyolefins, for example polypropylene (PP), polyhaloolefins, for example polyvinyl chloride (PVC), polystyrenes (PS), polyimides (PI), and combinations thereof. The term “composed” here can also in particular mean that the base layers or polymers can comprise additives, for example for improving thermal conductivity.

By way of example, the first and second base layer, or the first and second polymer, of the insulation foil used in step b) can comprise different additives, in particular for improving thermal conductivity. These can by way of example have been selected from the group consisting of boron nitride, aluminum oxide, aluminum nitride, and glass fibers, in particular boron nitride, aluminum oxide, aluminum nitride, and mixtures thereof.

As an alternative or in addition thereto, the first and second base layer, or the first and second polymer, can differ in that these comprise an additive system, comprise no additive system, or comprise different additive systems.

As an alternative, or in addition thereto, step b) can use an insulation foil which comprises at least one first adhesive layer and one second adhesive layer differing from the first adhesive layer. The first adhesive layer here can comprise a first adhesive or be composed thereof, and the second adhesive layer can comprise, or be composed of, a second adhesive differing from the first adhesive. In particular, the first adhesive layer here can comprise, or be composed of, a first adhesive selected from the group consisting of polysiloxane-based adhesives, acrylate-based adhesives, rubber-based adhesives, polyurethane-based adhesives, epoxy-resin-based adhesives, and combinations thereof. The second adhesive layer here can in particular comprise, or be composed of, a second adhesive differing from the first adhesive, likewise selected from the group consisting of polysiloxane-based adhesives, acrylate-based adhesives, rubber-based adhesives, polyurethane-based adhesives, epoxy-resin-based adhesives, and combinations thereof. The term “composed” here can in particular also mean that the adhesive layers, or the adhesives, can comprise additives, for example for improving thermal conductivity.

By way of example, the first and second adhesive layer, or the first and second adhesive, of the insulation foil used in step b) can comprise different additives, in particular for improving the thermal conductivity. These can by way of example have been selected from the group consisting of boron nitride, aluminum oxide, aluminum nitride, and glass fibers, in particular boron nitride, aluminum oxide, aluminum nitride, and mixtures thereof. As an alternative or in addition thereto, the first and second adhesive layer, or the first and second adhesive, can differ in that these comprise an additive system, comprise no additive system, or comprise different additive systems.

By way of example, the insulation foil used in step b) can comprise a layer system with a polyester base layer and with a base layer made of a polyolefin and/or silicone optionally comprising an additive for increasing thermal conductivity, an example being a thermosilicone foil, for example a thermosilicone foil marketed by Kunze, Germany, with trademark HEATPAD®. The layer system can moreover comprise one or two adhesive layers. The base layers and adhesive layers here can alternate in the arrangement. By way of example, the insulation foil used in step b) can comprise, for application by adhesive bonding to the housing structure, an adhesive layer which is adjacent to a base layer made of a polyolefin and/or silicone optionally comprising an additive for increasing thermal conductivity, where the base layer made of the polyolefin and/or silicone optionally comprising an additive for increasing thermal conductivity has been bonded by way of another adhesive layer to a polyester base layer, or vice versa.

For the purposes of another embodiment, step b) uses adhesive bonding to apply the insulation foil at least to the exterior sides and the exterior base of the housing structure. In particular, the type of adhesive bonding used to apply the insulation foil to the exterior sides and the exterior base of the housing structure in step b) can be such that the insulation foil covers the said areas to some extent or completely, in particular completely. The type of adhesive bonding used to apply the insulation foil to the exterior sides and the exterior base of the housing structure in step b) is preferably such that the sections of the insulation foil do not overlap one another or overlap one another only to a small extent, i.e. as necessary for insulation. It is thus advantageously possible to minimize the space requirement.

For the purposes of another embodiment, the shape of the insulation foil used in step b) corresponds at least to a flattened version of the planar regions of the exterior sides and of the exterior base of the housing structure (in one plane), in particular being similar to a partial geometric network of the housing structure. In particular, the shape of the insulation foil used in step b) can at least correspond to a flattened version of the planar regions of the exterior sides and of the exterior base of the housing structure, and of the curved external areas therebetween (in one plane).

The shape of the insulation foil used in step b) can moreover comprise a flattened version of at least one subregion of the exterior top area of the housing structure. In this section, the insulation foil used in step b) can also have cut-outs, by way of example for the poles of the electrochemical element. By way of example, for the purposes of this embodiment it is possible, after step a) and before or during step b) and step c) explained subsequently, to provide the housing structure with the electrochemical components of the electrochemical element to be produced, optionally seal the housing structure with a top panel, and then adhesive-bond said section on to or over the top area of the housing structure.

It is preferable that the shape of the insulation foil used in step b) is such that, after the adhesive bonding to the housing structure, sections of the foil do not overlap, or overlap only to a small extent, i.e. as necessary for insulation. As already explained, this has the advantage of minimizing the space required for the housing.

However, as an alternative or in addition, it is possible to achieve further optimization of the electrical insulation properties and the thermal conductivity of the housing by using, in another step c), adhesive bonding to apply another insulation foil to the insulation foil already applied by adhesive bonding in step b).

For the purposes of another embodiment, the process therefore also comprises, after step b), at least one step c) as follows: use of adhesive bonding to apply another insulation foil to the insulation foil applied by adhesive bonding by way of example in step b) or in a preceding step c).

For the purposes of another embodiment, the insulation foil used in step c) comprises a layer system made of at least one base layer and of at least one adhesive layer. Adhesive bonding can advantageously be used in step c) to apply the other insulation foil to the insulation foil previously applied by adhesive bonding, by using an adhesive layer, with resultant simplification of the process. The base layer of the insulation foil used in step c) is also preferably composed of a plastic. By way of example, the base layer of the insulation foil used in step c) can have a thickness≧10 μm, in particular ≧12 μm, for example from ≧10 μm to ≦70 μm, by way of example from ≧19 μm to ≦25 μm.

For the purposes of another embodiment, the insulation foil used in step c) comprises at least one base layer made of a polymer selected from the group consisting of polyesters, for example polyethylene terephthalate (PET) and/or polyethylene naphthalate (PEN), silicones, polyolefins, for example polypropylene (PP), polyhaloolefins, for example polyvinyl chloride (PVC), polystyrenes (PS), polyimides (PI), and combinations thereof. Polymers of this type have proven particularly advantageous as base layer. In particular, the at least one base layer of the insulation foil used in step c) can be composed of a polymer of this type. The term “composed” here can in particular mean that the polymer can comprise additives, for example in order to improve thermal conductivity. By way of example, the at least one base layer, or the polymer, of the insulation foil used in step c) can comprise at least one additive selected from the group consisting of boron nitride, aluminum oxide, aluminum nitride, and glass fibers, in particular boron nitride, aluminum oxide, aluminum nitride, and mixtures thereof. By way of example, the at least one base layer of the insulation foil used in step c) can be a thermosilicone foil, for example a thermosilicone foil marketed by Kunze, Germany, with trademark HEATPAD®.

Step c) can in principle use not only a pressure-sensitive adhesive but also an adhesive that sets by a chemical or physical route, for example a hot-melt adhesive. It is preferable that the insulation foil used in step c) comprises at least one adhesive layer made of a pressure-sensitive adhesive. It is thus advantageously possible to avoid waiting times and thermal effects for the setting process. The thickness of the at least one adhesive layer of the insulation foil used in step c) can by way of example be ≧10 μm, in particular ≧20 μm, for example from ≧25 μm to ≦35 μm.

For the purposes of another embodiment, the insulation foil used in step c) comprises at least one adhesive layer made of an adhesive selected from the group consisting of polysiloxane-based adhesives, acrylate-based adhesives, rubber-based adhesives, polyurethane-based adhesives, epoxy-resin-based adhesives, and combinations thereof. Adhesives of this type have proven to be particularly advantageous. In particular, the at least one adhesive layer of the insulation foil used in step c) can be composed of an adhesive of this type. The term “composed” here can in particular mean that the adhesive can comprise additives, for example in order to improve thermal conductivity. By way of example, the at least one adhesive layer of the insulation foil used in step c) can comprise at least one additive selected from the group consisting of boron nitride, aluminum oxide, aluminum nitride, and glass fibers, in particular boron nitride, aluminum oxide, aluminum nitride, and mixtures thereof.

The insulation foil used in step c) can in particular comprise a base layer of this type. By way of example, an insulation foil with a layer system made of a base layer and of an adhesive layer can be applied by adhesive bonding to the housing structure in step b), and another insulation foil with a layer system made of a base layer and of an adhesive layer being applied to the first foil by adhesive bonding in step c). Here, the adhesive layers and base layers of the insulation foils used in step b) and c) can be either identical or different. The term different applied here to base layers and/or adhesive layers can mean those having different constituent materials or else can mean base layers and/or adhesive layers which have the same constituent materials but a different, in particular percentage, constitution of constituent materials. By way of example, it is possible in step b) that an insulation foil with a layer system made of a base layer made of a polyolefin and/or silicone optionally comprising an additive to increase thermal conductivity, for example a thermosilicone foil, for example a thermosilicone foil marketed by Kunze, Germany with trademark HEATPAD®, and of an adhesive layer, is applied by adhesive bonding to the housing structure, another insulation foil with a layer system made of a polyester base layer and of an adhesive layer being applied thereto in step c), or vice versa.

It is also possible in step c) to use, or to apply by adhesive bonding, an insulation foil which comprises a layer system made of at least two base layers and of at least one adhesive layer, for example made of at least two base layers and at least two adhesive layers, in particular in an alternating arrangement. The base layers and/or adhesive layers of the insulation foil used in step c) here can likewise be of either identical or different design. The term different applied here again to base layers, adhesive layers, polymers, additives, and adhesives can mean those having different constituent materials or else can mean base layers, adhesive layers, polymers, additives, and adhesives which have the same constituent materials but a different, in particular percentage, constitution of constituent materials.

By way of example, step c) can use an insulation foil which comprises at least one first base layer and one second base layer differing from the first base layer. The first base layer here can comprise a first polymer or be composed thereof, and the second base layer can comprise a second polymer differing from the first polymer, or be composed thereof. In particular, the first base layer here can comprise, or be composed of, a first polymer selected from the group consisting of polyesters, for example polyethylene terephthalate (PET) and/or polyethylene naphthalate (PEN), silicones, polyolefins, for example polypropylene (PP), polyhaloolefins, for example polyvinyl chloride (PVC), polystyrenes (PS), polyimides (PI), and combinations thereof. The second base layer here can in particular comprise, or be composed of, a second polymer differing from the first polymer and likewise selected from the group consisting of polyesters, for example polyethylene terephthalate (PET) and/or polyethylene naphthalate (PEN), silicones, polyolefins, for example polypropylene (PP), polyhaloolefins, for example polyvinyl chloride (PVC), polystyrenes (PS), polyimides (PI), and combinations thereof. The term “composed” here can also in particular mean that the base layers or polymers can comprise additives, for example for improving thermal conductivity.

By way of example, the first and second base layer, or the first and second polymer, of the insulation foil used in step c) can comprise different additives, in particular for improving thermal conductivity. These can by way of example have been selected from the group consisting of boron nitride, aluminum oxide, aluminum nitride, and glass fibers, in particular boron nitride, aluminum oxide, aluminum nitride, and mixtures thereof. As an alternative or in addition thereto, the first and second base layer, or the first and second polymer, can differ in that these comprise an additive system, comprise no additive system, or comprise different additive systems.

As an alternative, or in addition thereto, step c) can use an insulation foil which comprises at least one first adhesive layer and one second adhesive layer differing from the first adhesive layer. The first adhesive layer here can comprise a first adhesive or be composed thereof, and the second adhesive layer can comprise, or be composed of, a second adhesive differing from the first adhesive. In particular, the first adhesive layer here can comprise, or be composed of, a first adhesive selected from the group consisting of polysiloxane-based adhesives, acrylate-based adhesives, rubber-based adhesives, polyurethane-based adhesives, epoxy-resin-based adhesives, and combinations thereof. The second adhesive layer here can in particular comprise, or be composed of, a second adhesive differing from the first adhesive, likewise selected from the group consisting of polysiloxane-based adhesives, acrylate-based adhesives, rubber-based adhesives, polyurethane-based adhesives, epoxy-resin-based adhesives, and combinations thereof. The term “composed” here can in particular also mean that the adhesive layers, or the adhesives, can comprise additives, for example for improving thermal conductivity.

By way of example, the first and second adhesive layer, or the first and second adhesive, of the insulation foil used in step c) can comprise different additives, in particular for improving thermal conductivity. These can by way of example have been selected from the group consisting of boron nitride, aluminum oxide, aluminum nitride, and glass fibers, in particular boron nitride, aluminum oxide, aluminum nitride, and mixtures thereof. As an alternative or in addition thereto, the first and second adhesive layer, or the first and second polymer, can differ in that these comprise an additive system, comprise no additive system, or comprise different additive systems.

It is preferable that in step c) the other insulation foil is applied by adhesive bonding at least to the exterior sides and the exterior base of the insulation foil previously applied by adhesive bonding for example in step b), or in a preceding step c). In particular, the manner of adhesive bonding of the other insulation foil in step c) to the exterior sides of the exterior base of the insulation foil previously applied by adhesive bonding can be such that the other insulation foil covers said areas to some extent or completely, in particular completely. The type of adhesive bonding used to apply the other insulation foil in step c) to the exterior sides and the exterior base of the other insulation foil previously applied by adhesive bonding is preferably such that the sections of the other insulation foil do not overlap one another or overlap one another only to a small extent, i.e. as necessary for insulation. It is thus advantageously possible to minimize the space requirement.

It is preferable that the shape of the insulation foil used in step c) corresponds at least to a flattened version of the planar regions of the exterior sides and of the exterior base of the housing structure to which insulation foils have been applied by adhesive bonding (from step b)) (in one plane), in particular being similar to a partial geometric network of the housing structure to which insulation foils have been applied by adhesive bonding. In particular, the shape of the insulation foil used in step c) can at least correspond to a flattened version of the planar regions of the exterior sides and of the exterior base of the housing structure to which insulation foils have been applied by adhesive bonding, and of the curved external areas therebetween (in one plane).

The shape of the insulation foil used in step c) can moreover comprise a flattened version at least of a subregion of the exterior top area of the housing structure to which insulation foils have been applied by adhesive bonding. In this section, the insulation foil used in step c) can also have cut-outs, by way of example for the poles of the electrochemical element. By way of example, for the purposes of this embodiment it is possible, after step a) and before or during step b) or c), to provide the housing structure with the electrochemical components of the electrochemical element to be produced, optionally seal the housing structure with a top panel, and then adhesive-bond said section on to or over the top area of the housing structure.

It is preferable that the shape of the insulation foil used in step c) is such that, after the adhesive bonding to the insulation foil applied by adhesive bonding beforehand, sections of the foil do not overlap, or overlap only to a small extent, i.e. as necessary for insulation. As already explained, this has the advantage of minimizing the space required for the housing.

In particular, the insulation foils used in step a) and c) can have different shapes which respectively correspond to different flattened versions. It is thus possible to close jointing gaps which can sometimes arise after the insulation foil has been applied by adhesive bonding in step b), via use of adhesive bonding to apply the other insulation foil shaped in the manner of another type of flattened version. It is thus advantageously possible in turn to achieve a further improvement in the electrical properties of the housing.

The shaping of the insulation foils used in step a) and optionally c) can be achieved by way of example via a punching process.

It is preferable that insulation foil is provided in step a) and optionally c) on a backing foil, in particular on a backing foil strip with a plurality of shaped insulation foils by way of example from a punching process. In particular, the adhesive layer of the insulation foil here can have been bonded to the backing foil. By way of example, the layer thickness of the backing foil or of the backing foil strip can be ≧20 μm, in particular ≧40 μm.

For the purposes of another embodiment, in step b) and/or optionally c) adhesive bonding is used to apply the insulation foil from a backing foil, in particular from a strip of backing foil, in particular automatically. The process can thus be advantageously further simplified. The insulation foil here can be peeled from the backing foil prior to or during step b) or c). In particular, in step a) or c) the insulation foil can be peeled from the backing foil and applied by adhesive bonding in one operation, in particular automatically.

During or after step b) and/or optionally c), pressure can be applied to the insulation foil, in particular over the relevant area, or the insulation foil can be applied to the housing structure, in particular over the relevant area, by using pressure. As an alternative, or in addition thereto, the insulation foil can be heated during or after step c) and/or optionally c), in particular over the relevant area. In both instances, the layer thickness of the insulation foil can decrease here. In particular, the layer thickness of the adhesive layer(s) can decrease by way of example by up to 25%, for example by up to 15%, of the original layer thickness. It is thus advantageously possible to increase the energy density of the cell, in particular when comparison is made with an insulation foil applied by shrinking. The thickness of the base layer(s) can remain unaltered here.

The thermal conductivity of the insulation foils used in step a) and/or c) can in particular be ≧0.10 W/(mK), for example≧0.15 W/(mK), and/or the dielectric strength can be ≧2 kV.

Prior to, during, or after step b) or c), the housing structure can be provided with electrochemical components of an electrochemical element, and can optionally be sealed with a top panel. The process of the invention can therefore also be used in the context of a process for the production of an electrochemical element.

In respect of other features and advantages of the process of the invention, explicit reference is hereby made to the explanations provided in connection with the housing, electrochemical element, module, and pack of the invention, and those provided in connection with the description of the figures.

The present invention further provides a housing for an electrochemical element, in particular a lithium ion cell, and which comprises a metallic housing structure with a wall thickness of ≧100 μm, and an insulation foil applied by adhesive bonding to at least one exterior area of the housing structure, and/or which has been produced via a process of the invention.

The metallic housing structure can by way of example have a wall thickness≧125 μm, for example≧150 μm, or ≧200 μm, or ≧400 μm, or ≧650 μm, for example≧100 μm, or ≧125 μm, or ≧150 μm, or ≧200 μm, or ≧400 μm, or ≧650 μm, and/or up to ≦1.5 mm, and/or can have been formed via a forming process, for example via forming under a combination of tensile and compressive conditions or by forming under compressive conditions, in particular via deep-drawing or extrusion.

In particular, the housing structure can be composed of aluminum, of an aluminum alloy, of iron, or of an iron alloy, such as stainless steel. By way of example, the housing structure can be a prismatic housing, for example with a plurality of, in particular four, sides, and with a base. The housing structure can moreover comprise electrochemical components and/or a top panel.

In principle, the insulation foil(s) can have been applied by adhesive bonding either with a pressure-sensitive adhesive (adhesive without hardening mechanism) or with an adhesive that sets chemically or physically, for example a hotmelt adhesive.

For the purposes of one preferred embodiment, the insulation foil applied by adhesive bonding to the housing structure comprises a layer system made of at least one base layer and of at least one adhesive layer. In particular, adhesive bonding can advantageously be used to apply the insulation foil to the housing structure, by using the adhesive layer, with resultant simplification of the process. The base layer of the insulation foil applied by adhesive bonding to the housing structure is preferably composed of a plastic. By way of example, the base layer of the insulation foil applied by adhesive bonding to the housing structure can have a thickness≧10 μm, in particular ≧12 μm, for example from ≧10 μm to ≦70 μm, by way of example from ≧19 μm to ≦25 μm.

For the purposes of another embodiment, the insulation foil applied by adhesive bonding to the housing structure comprises at least one base layer made of a polymer selected from the group consisting of polyesters, for example polyethylene terephthalate (PET) and/or polyethylene naphthalate (PEN), silicones, polyolefins, for example polypropylene (PP), polyhaloolefins, for example polyvinyl chloride (PVC), polystyrenes (PS), polyimides (PI), and combinations thereof. In particular, the at least one base layer of the insulation foil applied by adhesive bonding to the housing structure can be composed of a polymer of this type. By way of example, the at least one base layer, or the polymer, of the insulation foil applied by adhesive bonding to the housing structure can comprise at least one additive selected from the group consisting of boron nitride, aluminum oxide, aluminum nitride, and glass fibers, in particular boron nitride, aluminum oxide, aluminum nitride, and mixtures thereof. By way of example, the at least one base layer of the insulation foil applied by adhesive bonding to the housing structure can be a thermosilicone foil, for example a thermosilicone foil marketed by Kunze, Germany, with trademark HEATPAD®.

It is preferable that the insulation foil applied by adhesive bonding to the housing structure comprises at least one adhesive layer made of a pressure-sensitive adhesive. By way of example, the at least one adhesive layer of the insulation foil applied by adhesive bonding to the housing structure can have a thickness≧10 μm, in particular ≧20 μm, for example from ≦25 μm to ≧35 μm.

For the purposes of another embodiment, the insulation foil applied by adhesive bonding to the housing structure comprises at least one adhesive layer made of an adhesive selected from the group consisting of polysiloxane-based adhesives, acrylate-based adhesives, rubber-based adhesives, polyurethane-based adhesives, epoxy-resin-based adhesives, and combinations thereof. In particular, the at least one adhesive layer of the insulation foil applied by adhesive bonding to the housing structure can be composed of an adhesive of this type. By way of example, the at least one adhesive layer of the insulation foil applied by adhesive bonding to the housing structure can comprise at least one additive selected from the group consisting of boron nitride, aluminum oxide, aluminum nitride, and glass fibers, in particular boron nitride, aluminum oxide, aluminum nitride, and mixtures thereof.

It is preferable that the insulation foil applied by adhesive bonding to the housing structure comprises a layer system made of at least two base layers and of at least one adhesive layer, for example made of at least two base layers and of at least two adhesive layers, in particular in an alternating arrangement. The base layers and/or adhesive layers of the insulation foil applied by adhesive bonding to the housing structure here can be of either identical or different design.

By way of example, the insulation foil applied by adhesive bonding to the housing structure can comprise at least one first base layer and one second base layer differing from the first base layer. The first base layer here can comprise a first polymer or be composed thereof, and the second base layer can comprise a second polymer differing from the first polymer, or be composed thereof. In particular, the first base layer here can comprise, or be composed of, a first polymer selected from the group consisting of polyesters, silicones, polyolefins, polyhaloolefins, polystyrenes, polyimides, and combinations thereof. The second base layer here can in particular comprise, or be composed of, a second polymer differing from the first polymer and likewise selected from the group consisting of polyesters, silicones, polyolefins, polyhaloolefins, polystyrenes, polyimides, and combinations thereof. It is possible here that the first and second base layer, or the first and second polymer, of the insulation foil applied by adhesive bonding to the housing structure comprise different additives, in particular for improving thermal conductivity. These can by way of example have been selected from the group consisting of boron nitride, aluminum oxide, aluminum nitride, and glass fibers, in particular boron nitride, aluminum oxide, aluminum nitride, and mixtures thereof. As an alternative, or in addition thereto, the first and second base layer, or the first and second polymer, can differ from one another in that these comprise additives, or comprise no additives, or comprise different additives.

As an alternative or in addition thereto, the insulation foil applied by adhesive bonding to the housing structure can comprise at least one first adhesive layer and one second adhesive layer differing from the first adhesive layer. The first adhesive layer here can comprise a first adhesive or be composed thereof, and the second adhesive layer can comprise a second adhesive differing from the first adhesive, or be composed thereof. In particular, the first adhesive layer here can comprise, or be composed of, a first adhesive selected from the group consisting of polysiloxane-based adhesives, acrylate-based adhesives, rubber-based adhesives, polyurethane-based adhesives, epoxy-resin-based adhesives, and combinations thereof. The second adhesive layer here can in particular comprise, or be composed of, a second adhesive differing from the first adhesive and likewise selected from the group consisting of polysiloxane-based adhesives, acrylate-based adhesives, rubber-based adhesives, polyurethane-based adhesives, epoxy-resin-based adhesives, and combinations thereof.

It is possible here that the first and second adhesive layer, or the first and second adhesive, of the insulation foil applied by adhesive bonding to the housing structure comprise different additives, in particular for improving thermal conductivity. These can by way of example have been selected from the group consisting of boron nitride, aluminum oxide, aluminum nitride, and glass fibers, in particular boron nitride, aluminum oxide, aluminum nitride, and mixtures thereof. As an alternative, or in addition thereto, the first and second adhesive layer, or the first and second adhesive, can differ from one another in that these comprise additives, or comprise no additives, or comprise different additives.

By way of example, the insulation foil applied by adhesive bonding to the housing structure can comprise a layer system with a polyester base layer and with a base layer made of a polyolefin and/or silicone optionally comprising an additive for increasing thermal conductivity, an example being a thermosilicone foil, for example a thermosilicone foil marketed by Kunze, Germany, with trademark HEATPAD®. The layer system can moreover comprise one or two adhesive layers. The base layers and adhesive layers here can alternate in the arrangement. By way of example, the insulation foil applied by adhesive bonding to the housing structure can comprise an adhesive layer which is adjacent to the housing structure which borders a base layer made of a polyolefin and/or silicone optionally comprising an additive for increasing thermal conductivity, where the base layer made of the polyolefin and/or silicone optionally comprising an additive for increasing thermal conductivity has been bonded by way of another adhesive layer to a polyester base layer, or vice versa.

It is preferable that the insulation foil has been applied by adhesive bonding at least to the exterior sides and the exterior base of the housing structure. In particular, the type of adhesive bonding used to apply the insulation foil to the exterior sides and the exterior base of the housing structure can be such that the insulation foil covers said areas to some extent or completely, in particular completely. The type of adhesive bonding used to apply the insulation foil to the exterior sides and the exterior base of the housing structure is preferably such that the sections of the insulation foil do not overlap one another or overlap one another only to a small extent, i.e. as necessary for insulation.

For the purposes of another embodiment, the shape of the insulation foil applied by adhesive bonding to the housing structure corresponds at least to a flattened version of the planar regions of the exterior sides and of the exterior base of the housing structure (in one plane), in particular being similar to a partial geometric network of the housing structure. In particular, the shape of the insulation foil applied by adhesive bonding to the housing structure can at least correspond to a flattened version of the planar regions of the exterior sides and of the exterior base of the housing structure, and of the curved external areas therebetween (in one plane).

It is preferable that the shape of the insulation foil applied by adhesive bonding to the housing structure also comprises a flattened version of at least one subregion of the exterior top area of the housing structure. In this section, the insulation foil applied by adhesive bonding to the housing structure can also have cut-outs, for example for the poles of the electrochemical element. By way of example, for the purposes of this embodiment, this section of said insulation foil can have been adhesive-bonded to the top area of the housing structure.

It is preferable that the sections of the insulation foil applied by adhesive bonding to the housing structure do not overlap one another or overlap one another only to a small extent.

For the purposes of another embodiment, the housing therefore comprises another insulation foil applied by adhesive bonding to the insulation foil applied by adhesive bonding to the housing structure.

For the purposes of another embodiment, the other insulation foil comprises a layer system made of at least one base layer and of at least one adhesive layer. The other insulation foil can advantageously likewise, by using an adhesive layer, have been applied by adhesive bonding to the insulation foil applied by adhesive bonding to the housing structure. The base layer of the other insulation foil is also preferably composed of a plastic. By way of example, the base layer of the other insulation foil can have a thickness≧10 μm, in particular ≧12 μm, for example from ≧10 μm to ≦70 μm, by way of example from ≧19 μm to ≦25 μm.

For the purposes of another embodiment, the other insulation foil comprises at least one base layer made of a polymer selected from the group consisting of polyesters, silicones, polyolefins, polyhaloolefins, polystyrenes, polyimides, and combinations thereof. In particular, the at least one base layer of the other insulation foil can be composed of a polymer of this type. The at least one base layer, or the polymer, of the other insulation foil can by way of example comprise at least one additive selected from the group consisting of boron nitride, aluminum oxide, aluminum nitride, and glass fibers, in particular boron nitride, aluminum oxide, aluminum nitride, and mixtures thereof. By way of example, the at least one base layer of the other insulation foil can be a thermosilicone foil, for example a thermosilicone foil marketed by Kunze, Germany, with trademark HEATPAD®.

It is preferable that the other insulation foil comprises at least one adhesive layer made of a pressure-sensitive adhesive. The thickness of the at least one adhesive layer of the other insulation foil can by way of example be ≧10 μm, in particular ≧20 μm, for example from ≧25 μm to≦35 μm.

For the purposes of another embodiment, the other insulation foil comprises at least one adhesive layer made of an adhesive selected from the group consisting of polysiloxane-based adhesives, acrylate-based adhesives, rubber-based adhesives, polyurethane-based adhesives, epoxy-resin-based adhesives, and combinations thereof. In particular, the at least one adhesive layer of the other insulation foil can be composed of an adhesive of this type. The at least one adhesive layer of the other insulation foil can by way of example comprise at least one additive selected from the group consisting of boron nitride, aluminum oxide, aluminum nitride, and glass fibers, in particular boron nitride, aluminum oxide, aluminum nitride, and mixtures thereof.

The other insulation foil can by way of example comprise a base layer of this type. By way of example, not only the insulation foil applied by adhesive bonding to the housing structure but also the other insulation foil can comprise a layer system made of a base layer and of an adhesive layer. The adhesive layers and base layers here can be either identical or different. By way of example, the insulation foil applied by adhesive bonding to the housing structure can comprise a layer system made of a base layer made of a polyolefin and/or silicone optionally comprising an additive to increase thermal conductivity, an example being a thermosilicone foil, for example a thermosilicone foil marketed by Kunze, Germany with trademark HEATPAD®, and of an adhesive layer, where said layer system has been applied by adhesive bonding to the housing structure by using the adhesive layer, and where in turn another insulation foil with a layer system made of a polyester base layer and of an adhesive layer has been applied by adhesive bonding, in particular by using the adhesive layer, to the insulation foil applied by adhesive bonding to the housing structure, in particular has been applied to the base layer of said foil, or vice versa.

It is also possible that the other insulation foil comprises a layer system made of at least two base layers and of at least one adhesive layer, for example made of at least two base layers and of at least two adhesive layers, in particular in an alternating arrangement. The base layers and/or adhesive layers of the other insulation foil here can likewise be of either identical or different design.

By way of example, the other insulation foil can comprise a first base layer and a second base layer differing from the first base layer.

The first base layer here can comprise a first polymer or be composed thereof, and the second base layer can comprise a second polymer differing from the first polymer, or be composed thereof. In particular, the first base layer here can comprise, or be composed of, a first polymer selected from the group consisting of polyesters, silicones, polyolefins, polyhaloolefins, polystyrenes, polyimides, and combinations thereof. The second base layer here can in particular comprise, or be composed of, a second polymer differing from the first polymer and likewise selected from the group consisting of polyesters, silicones, polyolefins, polyhaloolefins, polystyrenes, polyimides, and combinations thereof. By way of example, it is possible here that the first and second base layer, or the first and second polymer, of the other insulation foil comprise different additives, in particular for improving thermal conductivity. These can by way of example have been selected from the group consisting of boron nitride, aluminum oxide, aluminum nitride, and glass fibers, in particular boron nitride, aluminum oxide, aluminum nitride, and mixtures thereof. As an alternative, or in addition thereto, the first and second base layer, or the first and second polymer, can differ from one another in that these comprise additives, or comprise no additives, or comprise different additives.

Alternatively or additionally in this the further insulation foil may comprise at least one first and one second—different from the first-layer of adhesive. In this case the first layer of adhesive may be formed of or comprise a first adhesive and the second layer of adhesive may be formed of or comprise a second adhesive, different from the first. More particularly, said first layer of adhesive may be formed of or comprise a first adhesive which is selected from the group consisting of polysiloxane-based adhesives, acrylate-based adhesives, rubber-based adhesives, polyurethane-based adhesives, epoxyresin-based adhesives, and combinations thereof. Said second layer of adhesive may more particularly be formed of or comprise a second adhesive, different from the first and likewise selected from the group consisiting of polysiloxane-based adhesives, acrylate-based adhesives, rubber-based adhesives, polyurethane-based adhesives, epoxyresin-based adhesives, and combinations thereof. For example, the first and second layers of adhesive, or first and second adhesives, of the insulation foil may comprise various additives, especially for improving the thermal conductivity. They may be selected, for example, from ther group consisting of boron nitride, aluminum oxide, aluminum nutride, and glass fibres, more particularly boron nitride, aluminum oxide, aluminum nitride, and mixtures thereof. Alternatively or additionally the first and second layers of adhesive, or first and second adhesives, may differ in being additized, unadditized, or differently additized.

It is preferable that the other insulation foil has been applied by adhesive bonding at least to the outer sides and the outer base of the insulation foil applied by adhesive bonding to the housing structure. In particular, the type of adhesive bonding used to apply the other insulation foil to the exterior sides and the exterior base of the insulation foil applied by adhesive bonding to the housing structure can be such that the other insulation foil covers the said areas to some extent or completely, in particular completely. The type of adhesive bonding used to apply the other insulation foil to the exterior sides and the exterior base of the insulation foil applied by adhesive bonding to the housing structure is preferably such that the sections of the other insulation foil do not overlap one another or overlap one another only to a small extent, i.e. as necessary for insulation.

It is preferable that the shape of the other insulation foil corresponds to at least one flattened version of the planar regions of the exterior sides and of the exterior base of the housing structure to which insulation foils have been applied by adhesive bonding (in one plane), in particular being similar to a partial geometric network of the housing structure to which insulation foils have been applied by adhesive bonding. In particular, the shape of the other insulation foil can at least correspond to a flattened version of the planar regions of the exterior sides and of the exterior base of the housing structure to which insulation foils have been applied by adhesive bonding, and of the curved external areas therebetween (in one plane).

The shape of the other insulation foil can moreover comprise at least one subregion of the exterior top area of the housing structure to which insulation foils have been applied by adhesive bonding. In this section, the other insulation foil can also have cut-outs, for example for the poles of the electrochemical element.

It is preferable that the sections of the other insulation foil do not overlap one another, or overlap one another only to a small extent.

In particular, the shapes of the insulation foil applied by adhesive bonding to the housing structure and of the other insulation foil can differ, respectively corresponding to different flattened versions.

The thermal conductivity of the insulation foil applied by adhesive bonding to the housing structure, and of the other insulation foil, can in particular be 0.10 W/(mK), for example 0.15 W/(mK), and/or the dielectric strength of these foils can be 2 kV.

In respect of advantages, definitions and other features, explicit reference is hereby made to the explanations provided in connection with the process, electrochemical element, module, and pack of the invention, and those provided in connection with the description of the figures.

The present invention also provides an electrochemical element, in particular a lithium ion cell, which comprises a housing of the invention and/or which has been produced via a process of the invention. The invention further provides an electrochemical module, in particular a lithium ion module, which comprises two or more electrochemical elements of the invention; and an electrochemical pack, in particular a lithium ion pack, which comprises two or more electrochemical modules of the invention.

In respect of other features and advantages of the electrochemical element, module, and pack of the invention, explicit reference is hereby made to the explanations provided in connection with the process and housing, and those provided in connection with the description of the figures.

### DRAWINGS AND EXAMPLES

Other advantages and advantageous embodiments of the subject matter of the invention are illustrated by the drawings and explained in the description below. It should be noted here that the drawings are merely descriptive and are not intended to restrict the invention in any way.

FIG. 1 is a greatly enlarged cross-sectional diagram of a first embodiment of a housing of the invention;

FIG. 2 is a cross-sectional diagram of a first embodiment of an electrochemical element of the invention with a housing of the invention;

FIG. 3a is a perspective diagram of a second embodiment of an electrochemical element of the invention with a housing of the invention;

FIG. 3b is a diagram of a plan view of a first embodiment of an insulation foil for a housing of the invention;

FIG. 3c is a diagram of a plan view of the second embodiment of an insulation foil for a housing of the invention; and

FIG. 4 is a diagram of a plan view of a third embodiment of an insulation foil for a housing of the invention.

FIG. 1 shows that for the purposes of this embodiment the housing comprises a metallic housing structure 1 and an insulation foil 2, 3 applied by adhesive bonding to the housing structure 1. FIG. 1 also illustrates that the insulation foil 2, 3 comprises a layer system made of a base layer 3 and of an adhesive layer 2, and has been applied by adhesive bonding to the exterior side S and the housing structure by way of the adhesive layer 2.

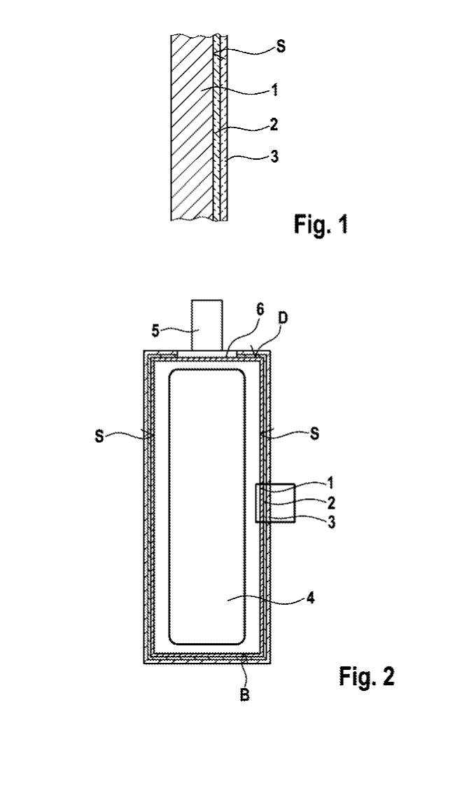

FIG. 2 shows a first embodiment of an electrochemical element of the invention with a housing of the invention, where the housing comprises a prismatic housing structure 1, and an insulation foil 2, 3 made of an adhesive layer 2 and of a base layer 3, and comprises a top panel 6. FIG. 2 illustrates that for the purposes of this embodiment the insulation foil 2, 3 has been applied by adhesive bonding to the exterior sides S and the exterior base B of the housing structure 1 and to a subregion of the exterior area D of the top panel 6. FIG. 2 moreover shows that electrochemical components 4 have been arranged within the housing and are electrically contactable from outside of the housing by way of a pole 5. FIG. 2 also illustrates that the insulation foil 2, 3 comprises a cut-out in the region of the pole 5 of the exterior top area D.

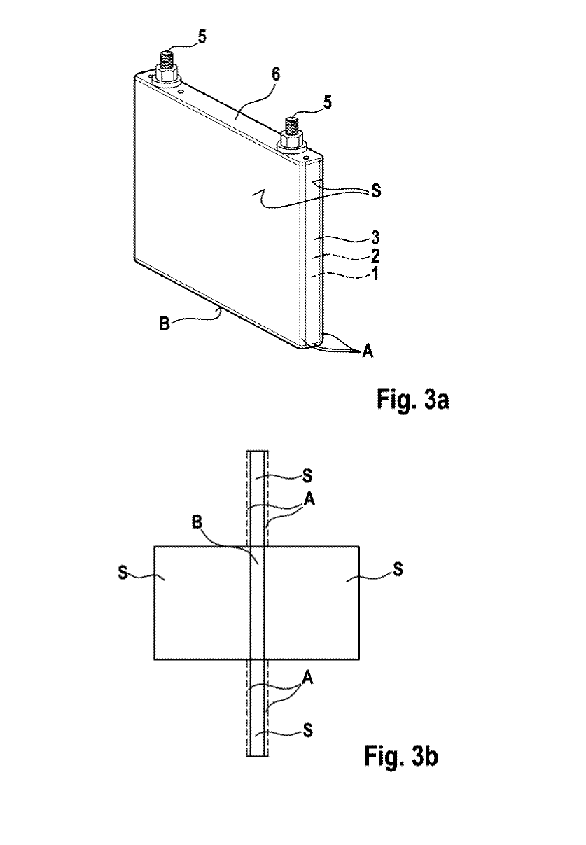

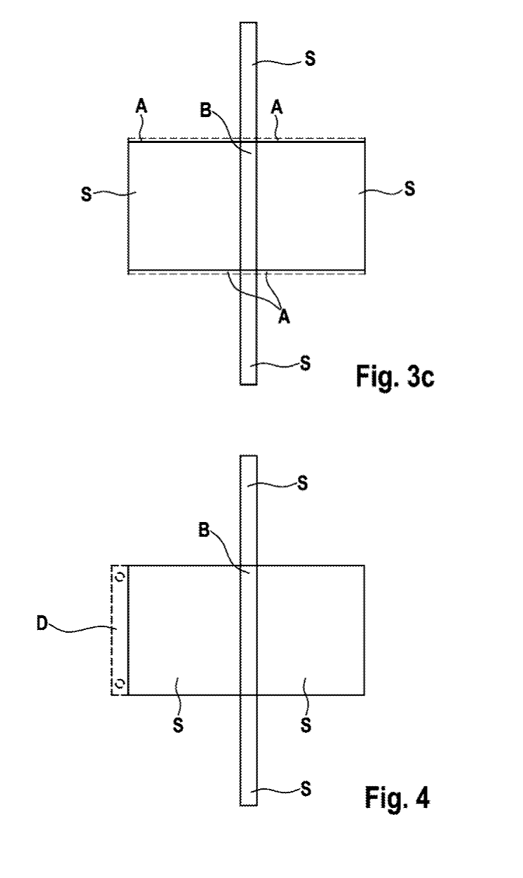

FIG. 3a shows a second embodiment of an electrochemical element of the invention. For the purposes of this embodiment, in contrast to the second embodiment shown in FIG. 2, the insulation foil 2, 3 has been applied by adhesive bonding only to the exterior sides S and the exterior base B of the housing structure 1. For the purposes of this embodiment, there is nothing covering the exterior top area D of the top panel 6. FIG. 3 moreover illustrates that between planar regions of the exterior sides S and the exterior base B (not visible) of the housing structure there are curved external areas A of the housing structure 1. These can be produced by way of example during the deep-drawing or extrusion of the housing structure 1.

FIGS. 3b and 3c are diagrams of plan views of a first and second embodiment of an insulation foil 2, 3 which can also be used for adhesive bonding to the curved external areas A shown in FIG. 3a on the housing structure 1. FIGS. 3b and 3c illustrate that the shape of the insulation foil 2, 3 corresponds to a flattened version, in a single plane, of the planar regions of the exterior sides S and of the exterior base B of the housing structure 1, and of the curved external areas A located therebetween on the housing structure 1, and is similar to a partial geometric network. The insulation foils thus shaped can be applied by adhesive bonding to the exterior sides S, exterior base B, and external areas A located therebetween on the housing structure 1, in such a way that the insulation foil 2, 3 covers these completely, and the individual sections of the insulation foil 2, 3 here do not overlap one another, or overlap one another only to a small extent, i.e. as necessary for insulation.

FIG. 4 is a diagram of a plan view of a third embodiment of an insulation foil 2, 3 for a housing of the invention, where the shape of the foil corresponds to a flattened version of the planar regions of the exterior sides S and of the exterior base B of the housing structure 1, and of a subregion of the exterior top area D of the housing structure 1. FIG. 4 illustrates that for the purposes of this embodiment the insulation foil 2, 3 can comprise cut-outs in the section of the subregion of the exterior top area D, for example for the poles 5 of the electrochemical element. By way of example, for the purposes of this embodiment it is possible, after step a) and before or during step b), to provide the housing structure 1 with electrochemical components 4, optionally seal the housing structure 1 with a top panel 6, and then adhesive-bond said section on to or over the top area D of the housing structure 1.

The shaped insulation foils shown in FIGS. 3b, 3c, and 4 can be provided on a backing foil or on a backing foil strip with a plurality of said shapes, and in step b) can be directly automatically applied by adhesive bonding from the backing foil to the housing structure.

### INVENTIVE EXAMPLES

### Variant 1

An insulation foil with a 23 μm polyester base layer and a 35 μm polysiloxane adhesive layer from PPI (Ireland), on a 50 μm backing foil, was cut with a scalpel so as to correspond to the shape of a deep-drawn aluminum housing structure, peeled from the backing foil, and arranged around the housing. Pressure was then used to apply the insulation foil over the relevant area. Polished sections were then prepared.

The thickness of the polyester base layer was unaltered at 23 μm. However, the thickness of the polysiloxane adhesive layer was reduced from 35 μm to 30 μm. Peel tests show that the adhesive strip has adequate adhesion. After one month of aging under humid tropical conditions at 60° C. and 90% humidity, adhesion results achieved were identical with those prior to aging. Initial analytical calculations of the effective heat dissipation from the cell showed that, by virtue of the low layer thickness, the thermal conductivity of the insulation foil has hardly any effect on the total heat dissipation from the cell.

### Variant 2

An insulation foil with a 50 μm polyester base layer and a 35 μm polysiloxane adhesive layer from PPI (Ireland), on a 50 μm backing foil, was cut with a scalpel so as to correspond to the shape of a deep-drawn aluminum housing structure, peeled from the backing foil, and arranged around the housing. Pressure was then used to apply the insulation foil over the relevant area. Polished sections were then prepared.

The thickness of the polyester base layer was unaltered at 50 μm. However, the thickness of the polysiloxane adhesive layer was reduced from 35 μm to 30 μm. Peel tests show that the adhesive strip has adequate adhesion. After one month of aging under humid tropical conditions at 60° C. and 90% humidity, adhesion results achieved were identical with those prior to aging. Initial analytical calculations of the effective heat dissipation from the cell showed that, by virtue of the low layer thickness, the thermal conductivity of the insulation foil has hardly any effect on the total heat dissipation from the cell.

1. A method for the production of a housing for an electrochemical element, comprising:
molding a metallic housing structure; and
applying a first insulation foil by adhesive bonding to at least one external area of the metallic housing structure.

2. The method as claimed in claim 1, further comprising:
applying a second insulation foil by adhesive bonding to the first insulation foil.

3. The method as claimed in claim 1, wherein at least one of the first insulation foil and the second insulation foil includes a layer system having at least one base layer and at least one adhesive layer.

4. The method as claimed in claim 1, wherein at least one of the first insulation foil and the second insulation foil includes at least one base layer made of a polymer selected from the group consisting of polyesters, silicones, polyolefins, polyhaloolefins, polystyrenes, polyimides, and combinations thereof.

5. The method as claimed in claim 1, wherein at least one of the first insulation foil and the second insulation foil includes at least one adhesive layer made of an adhesive selected from the group consisting of polysiloxane-based adhesives, acrylate-based adhesives, rubber-based adhesives, polyurethane-based adhesives, epoxy-resin-based adhesives, and combinations thereof.

6. The method as claimed in claim 1, wherein adhesive bonding is used to apply the first insulation foil at least to exterior sides and an exterior base of the metallic housing structure.

7. The method as claimed in claim 6, wherein a shape of the first insulation foil corresponds at least to a flattened version of planar regions of the exterior sides and of the exterior base.

8. The method as claimed in claim 1, wherein adhesive bonding is used to automatically apply at least one of the first insulation foil and the second insulation foil from a strip of backing foil.

9. A housing for a lithium ion cell, comprising:
a metallic housing structure defining a wall thickness that is greater than or equal to 100 μm; and
a first insulation foil applied by adhesive bonding to at least one external area of the metallic housing structure.

10. The housing as claimed in claim 9, further comprising:
a second insulation foil applied by adhesive bonding to the first insulation foil.

11. The housing as claimed in claim 10, wherein at least one of the first insulation foil and the second insulation foil includes a layer system having at least one base layer and at least one adhesive layer.

12. The housing as claimed in claim 10, wherein at least one of the first insulation foil and the second insulation foil includes at least one base layer made of a polymer selected from the group consisting of polyesters, silicones, polyolefins, polyhaloolefins, polystyrenes, polyimides, and combinations thereof.

13. The housing as claimed in claim 10, wherein at least one of the first insulation foil and the second insulation foil includes at least one adhesive layer made of an adhesive selected from the group consisting of polysiloxane-based adhesives, acrylate-based adhesives, rubber-based adhesives, polyurethane-based adhesives, epoxy-resin-based adhesives, and combinations thereof.

14. The housing as claimed in claim 9, wherein the shape of the first insulation foil corresponds at least to a flattened version of planar regions of exterior sides and of an exterior base of the metallic housing structure.

15. The housing as claimed in claim 9, wherein a lithium ion cell includes the housing.
